(19) United States
(12) Patent Application Publication
(10) Pub. No.: US 2024/0388414 A1
(43) Pub. Date: Nov. 21, 2024

(54) METHOD, DEVICE, AND SYSTEM FOR DETERMINING TIMING IN WIRELESS NETWORKS

(71) Applicant: ZTE Corporation, Shenzhen (CN)

(72) Inventor: Peng HAO, Shenzhen (CN)

(73) Assignee: ZTE Corporation, Shenzhen (CN)

(21) Appl. No.: 18/789,939

(22) Filed: Jul. 31, 2024

Related U.S. Application Data
(63) Continuation of application No. PCT/CN2022/103470, filed on Jul. 1, 2022.

(51) Int. Cl. H04L 5/14; H04L 5/00; H04W 56/00

(52) U.S. Cl. CPC H04L 5/1469; H04L 5/0048; H04L 5/0078; H04W 56/0045

(57) ABSTRACT

This disclosure relates generally to a method, device, and system for determining timing information for uplink and downlink transmission in a wireless network. One method performed by a wireless device is disclosed. The method may include at least one of: configuring two DL timings for DL transmission from a network element, wherein the two DL timings include a first DL timing and a second DL timing; or configuring two UL timings for UL transmission to the network element, wherein the two UL timings include a first UL timing and a second UL timing; and wherein each of the two DL timings and each of the two UL timings are associated with a time block for the DL transmission or the UL transmission.

### TECHNICAL FIELD

This disclosure is directed generally to wireless communications, and particularly to a method, device, and system for determining timing information for uplink and downlink transmission in a wireless network.

### BACKGROUND

Flexible and efficient wireless transmission resource scheduling is critical in the wireless communication network. The ecosystem in a wireless communication network includes more and more applications that require low latency. These applications include Vehicle-to-Vehicle Communication, self-driving, mobile gaming, etc. Specifically, when Time Division Multiplex (TDD) is deployed in the wireless network, in order to reduce transmission latency, it is desirable to enable full duplex data/signal transmission for certain slot and/or symbols. Sub-band Full Duplex (SBFD) is an important feature for implementing full duplex in TDD system. Determining timing information is critical in SBFD, for example, to reduce self-interference strength, ease difficulty of self-interference cancellation, reduce Channel State Information (CSI) feedback overhead, and boost system performance.

### SUMMARY

This disclosure is directed to a method, device, and system for determining timing information for uplink and downlink transmission in a wireless network, and in particular, in a TDD system deploying the SBFD feature.

In some embodiments, a method performed by a wireless device is disclosed. The method may include at least one of: configuring two downlink (DL) timings for DL transmission from a network element, wherein the two DL timings include a first DL timing and a second DL timing; or configuring two uplink (UL) timings for UL transmission to the network element, wherein the two UL timings include a first UL timing and a second UL timing; and wherein each of the two DL timings and each of the two UL timings are associated with a time block for the DL transmission or the UL transmission.

In some embodiments, the method above may further include: the first UL timing is based on a timing advance value; and the second UL timing is based on the timing advance value and a timing advance offset value.

In some embodiments, the method above may further include: the first DL timing is determined based on a reference signal, the reference signal comprising at least one of: a Synchronization Signal Block (SSB), or a Channel State Information Reference Signal (CSI-RS).

In some embodiments, the method above may further include: the second DL timing is based on the first DL timing, and a timing advance offset value.

In some embodiments, a method performed by a network element is disclosed. The method may include: configuring two UL timings for UL transmission, wherein the two UL timings include a first UL timing and a second UL timing.

In some embodiments, the method above may further include: the second UL timing is based on the first UL timing and a timing advance offset value; or the first UL timing is based on the second UL timing and the timing advance offset value.

In some embodiments, the method above may further include: configuring two DL timings for DL transmission, wherein the two DL timings include a first DL timing and a second DL timing.

In some embodiments, there is a network element or a UE comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments.

The above embodiments and other aspects and alternatives of their implementations are described in greater detail in the drawings, the descriptions, and the claims below.

### BRIEF DESCRIPTION OF THE DRAWINGS

FIG. 1 shows an example wireless communication network.

FIG. 2 shows an example wireless network node.

FIG. 3 shows an example user equipment.

FIG. 4 shows an exemplary transmission resource and a pattern/format thereof.

FIG. 5 shows an exemplary Sub-band Full Duplex (SBFD) implementation.

FIGS. 6A and 6B shows exemplary transceiver structures for implementing SBFD.

FIG. 7 shows timing advance under wireless system frame structure.

FIG. 8 shows example Uplink (UL) timing and Downlink (DL) timing from both base station (BS) side and UE side.

FIGS. 9-19 show exemplary implementations of DL and/or UL timing.

### DETAILED DESCRIPTION

### Wireless Communication Network

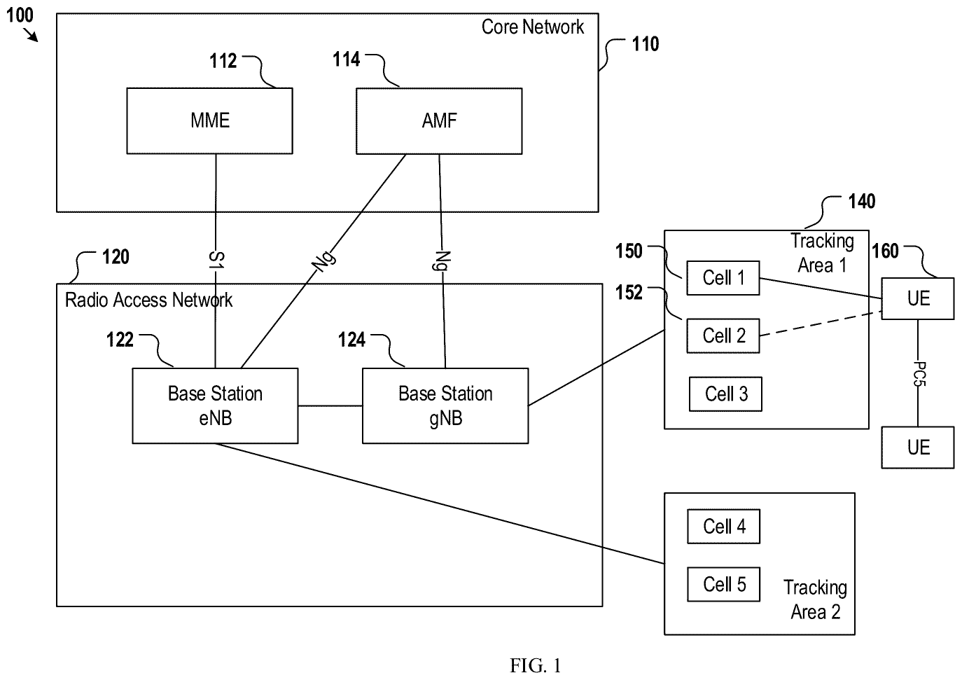

FIG. 1 shows an exemplary wireless communication network 100 that includes a core network 110 and a radio access network (RAN) 120. The core network 110 further includes at least one Mobility Management Entity (MME) 112 and/or at least one Access and Mobility Management Function (AMF). Other functions that may be included in the core network 110 are not shown in FIG. 1. The RAN 120 further includes multiple base stations, for example, base stations 122 and 124. The base stations may include at least one evolved NodeB (eNB) for 4G LTE, an enhanced LTE eNB (ng-eNB), or a Next generation NodeB (gNB) for 5G New Radio (NR), or any other type of signal transmitting/receiving device such as a UMTS NodeB. The eNB 122 communicates with the MME 112 via an S1 interface. Both the eNB 122 and gNB 124 may connect to the AMF 114 via an Ng interface. Each base station manages and supports at least one cell. For example, the base station gNB 124 may be configured to manage and support cell 1, cell 2, and cell 3.

The gNB 124 may include a central unit (CU) and at least one distributed unit (DU). The CU and the DU may be co-located in a same location, or they may be split in different locations. The CU and the DU may be connected via an F1 interface. Alternatively, for an eNB which is capable of connecting to the 5G network, it may also be similarly divided into a CU and at least one DU, referred to as ng-eNB-CU and ng-eNB-DU, respectively. The ng-eNB-CU and the ng-eNB-DU may be connected via a W1 interface.

The wireless communication network 100 may include one or more tracking areas. A tracking area may include a set of cells managed by at least one base station. For example, tracking area 1 labeled as 140 includes cell 1, cell 2, and cell 3, and may further include more cells that may be managed by other base stations and not shown in FIG. 1. The wireless communication network 100 may also include at least one UE 160. The UE may select a cell among multiple cells supported by a base station to communication with the base station through Over the Air (OTA) radio communication interfaces and resources, and when the UE 160 travels in the wireless communication network 100, it may reselect a cell for communications. For example, the UE 160 may initially select cell 1 to communicate with base station 124, and it may then reselect cell 2 at certain later time point. The cell selection or reselection by the UE 160 may be based on wireless signal strength/quality in the various cells and other factors.

The wireless communication network 100 may be implemented as, for example, a 2G, 3G, 4G/LTE, or 5G cellular communication network. Correspondingly, the base stations 122 and 124 may be implemented as a 2G base station, a 3G NodeB, an LTE eNB, or a 5G NR gNB. The UE 160 may be implemented as mobile or fixed communication devices which are capable of accessing the wireless communication network 100. The UE 160 may include but is not limited to mobile phones, laptop computers, tablets, personal digital assistants, wearable devices, Internet of Things (IOT) devices, MTC/eMTC devices, distributed remote sensor devices, roadside assistant equipment, XR devices, and desktop computers. The UE 160 may also be generally referred to as a wireless communication device, or a wireless terminal. The UE 160 may support sidelink communication to another UE via a PC5 interface.

While the description below focuses on cellular wireless communication systems as shown in FIG. 1, the underlying principles are applicable to other types of wireless communication systems for paging wireless devices. These other wireless systems may include but are not limited to Wi-Fi, Bluetooth, ZigBee, and WiMax networks.

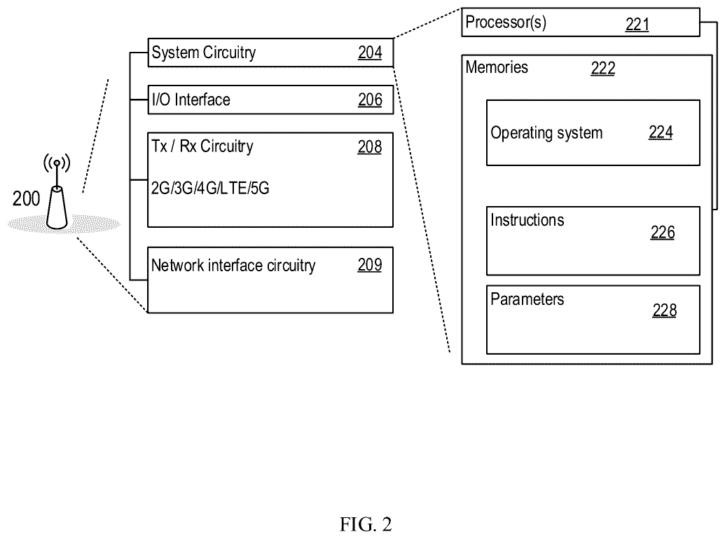

FIG. 2 shows an example of electronic device 200 to implement a network base station (e.g., a radio access network node), a core network (CN), and/or an operation and maintenance (OAM). Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

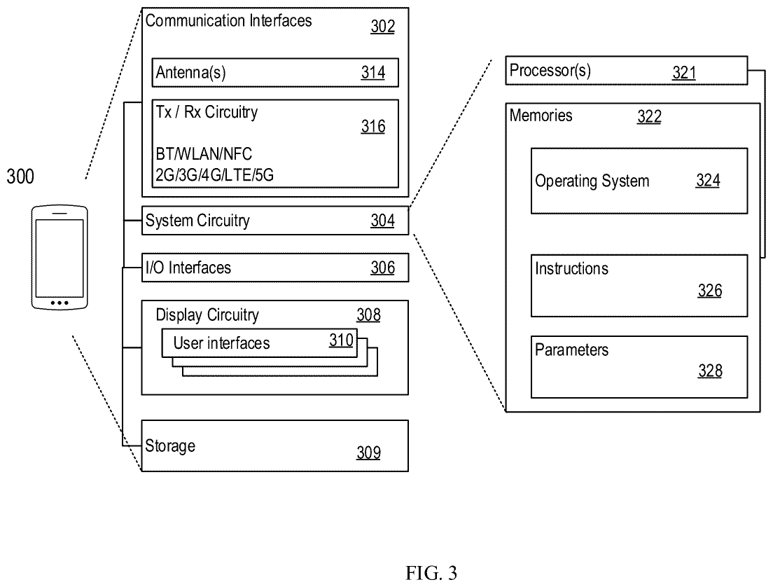

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

### Transmission Resource in Wireless Network

In a wireless network, data and/or signal are transmitted using wireless transmission resource. The transmission resource may be presented as a two-dimensional grid with time being one dimension and frequency being the other dimension.

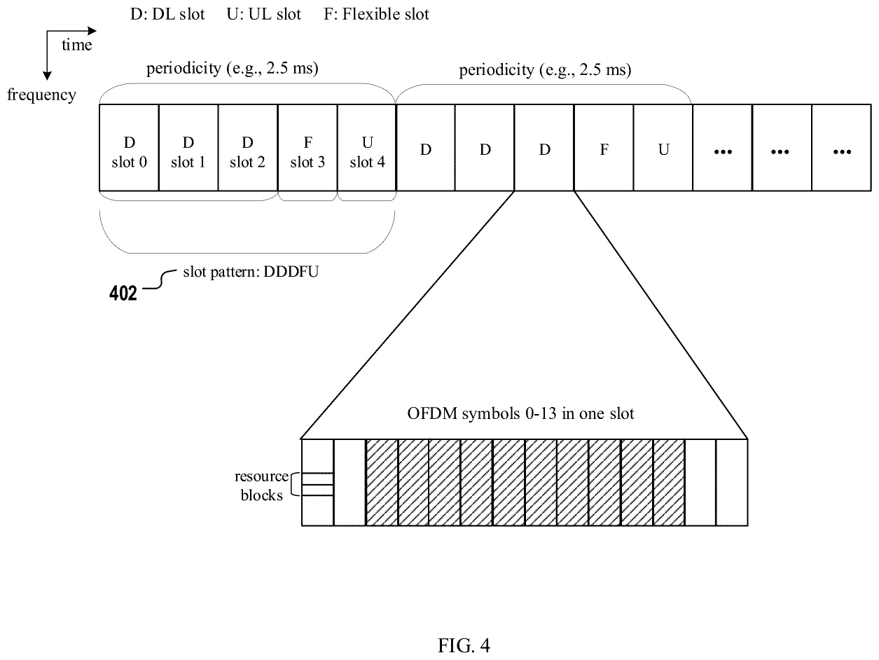

Referring to FIG. 4 for an exemplary transmission resource configuration in a wireless network, such network may be operated in TDD mode. In the time domain, the transmission resource may be organized by time block, such as slot (or time slot), like slot 0 to slot 4 as shown in FIG. 4. Based on data/signal transmission direction, a slot may be assigned to a downlink (DL) direction, in which case the slot is dedicated to DL transmission/traffic. A slot may also be assigned to an uplink (UL) direction, in which case the slot the slot is dedicated for UL transmission/traffic. A slot may also be configured as a flexible slot, in the sense that the slot may be configured flexibly to support both DL and UL traffic. Further, the flexible slot may support both DL and UL transmission simultaneously, or, the flexible slot may support DL transmission in one cycle, and support UL transmission another cycle. The direction assigned to a slot may be associated with a format of the slot. For example, a DL format (or D format) slot is dedicated to DL transmission; a UL format (or U format) slot is dedicated to UL transmission; a flexible format (or F format) slot may support bi-directional transmission.

The transmission resource may present periodically. Exemplarily, as shown in FIG. 4, the transmission resource 402 has a “DDDFU” pattern (D: DL slot; F: flexible slot; U: UL slot). The character “D”, “U”, and “F” may each represent a format of a slot. In this example, this particular pattern has a periodicity of 2.5 millisecond (ms).

It should be noted that the aforementioned “DDDFU” pattern and its periodicity are merely for example purpose. Other patterns and associated periodicities may be configured based on a practical requirement. A pattern may be a combination of various number of slots in various formats. For example, an example pattern may be “DDDDFUU”. In this pattern, there are 4 continuous DL slots, a single flexible slot, and 2 continuous UL slots.

In some embodiment, the format, such as DL, UL, and flexible format may also generally apply to a time block such as a symbol. The symbol may include at least one of:
Orthogonal Frequency Division Multiplexing (OFDM) symbol;
Single Carrier Frequency Division Multiplexing Access (SC-FDMA) symbol; or
Filter Bank Multiple Access (FBMA) symbol.

Using OFDM symbol as an example, each slot may include multiple Orthogonal Frequency Division Multiplexing (OFDM) symbols. Referring to FIG. 4, a slot may include 14 OFDM symbols. In the frequency domain, each symbol may include multiple Resource Blocks (RBs). The number of RBs in each OFDM symbol may depend on, for example, the bandwidth of the cell or the carrier.

In a conventional TDD system, there is no specific frequency resource dedicated to downlink or uplink. One frequency resource may be used for downlink transmission, uplink transmission or both downlink and uplink transmission in TDD manner.

### Sub-band Full Duplex (SBFD)

In an exemplary wireless network operating in TDD mode, as discussed above, the data/signal transmission (and associated time block) may follow a certain pattern, such as “DDDFU”. The following discussion will be based on this pattern although it will be appreciated that the transmission may follow other various patterns. The discussion will use slot for example purpose, and other time block may apply as well. In the “DDDFU” pattern, slots 0-2 are DL slots, slot 3 is flexible slot, whereas slot 4 is UL slot. The resulting DL and UL traffic is therefore time division duplexed as per the transmission slot pattern. It is overserved that UL transmission has only a single dedicated slot. From a network performance perspective, UL transmission may suffer from excessive latency since the UE is restricted to transmitting in the single dedicated U slot and in the UL resource allocated in the flexible slot. This may lead to performance issue, especially for latency sensitive applications, such as intelligent transport systems, vehicle to vehicle communications, remote surgery, etc. Another factor to consider is that the transmission energy for the UL communication is constrained to the dedicated U slot, and this may lead to sub-optimal or degraded radio coverage.

To address the aforementioned issues with regard to latency and transmission energy limitation, one solution is to introduce a Sub-band Full Duplex (SBFD) mode to the wireless network. Advantage of SBFD may include enhanced signal coverage and reduced communication latency.

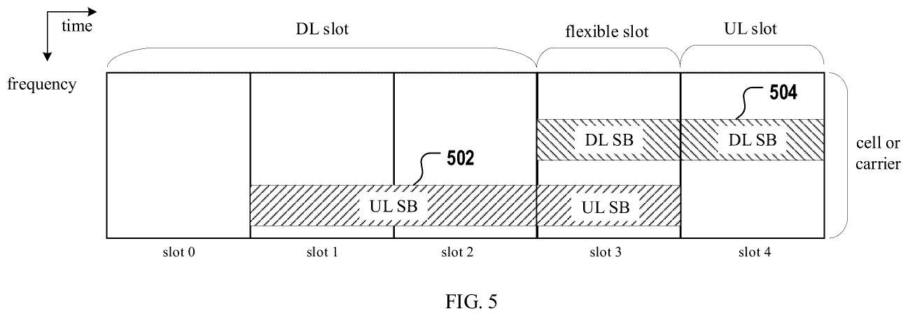

SBFD may be implemented in various ways. For example, one possible implementation is via sub-bands. Referring to FIG. 5, slots 1-2, which are originally dedicated to DL transmission, may be re-configured so that a portion of spectrum resource in slots 1-2 may be allocated to create a UL sub-band (UL SB 502) to support UL transmission, while the rest of spectrum resource still supports DL transmission. Therefore, simultaneous DL and UL transmissions may be achieved in slots 1-2. Likewise, slot 4, which is originally dedicated to UL transmission, may be re-configured and a portion of spectrum resource (DL SB 504) may be allocated to support DL transmission. In this example, slot 0 remains in original format (D) and it is still dedicated to DL transmission. In some embodiments, a sub-band, such as UL SB 502 and DL SB 504, may be formed by one or more resource blocks.

Another possible implementation of SBFD is via multiple Bandwidth Parts (BWPs). For example, multiple BWPs may be configured and activated simultaneously, and each activated BWP may have its own DL and/or UL configuration, such as pattern and periodicity. With multiple activated BWPs, it is possible that for a given time and for a given UE, one BWP is allocated for DL transmission and another BWP is allocated for UL transmission.

### Timing in Wireless System

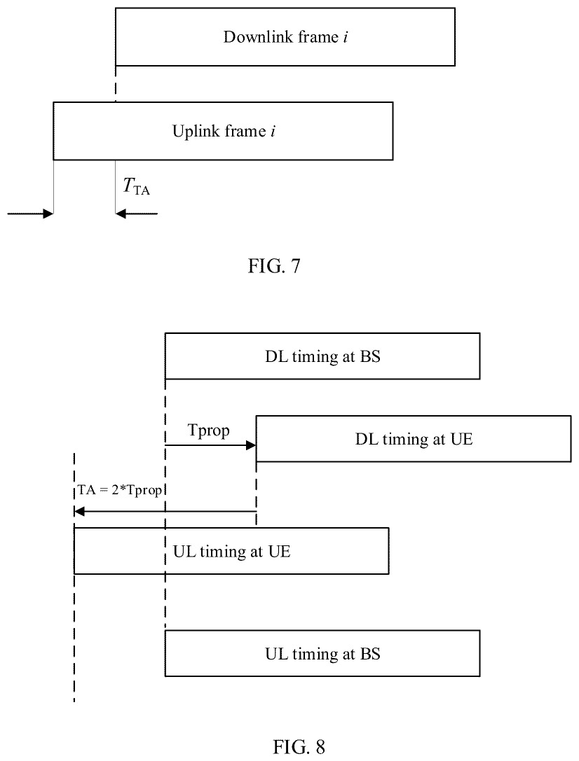

In a wireless system, UL frame is transmitted by UE towards a base station whereas the DL frame is transmitted by the base station towards UE. There is one set of frames in the uplink and one set of frames in the downlink on a carrier. Uplink frame number i for transmission from the UE shall start T_{TA} before the start of the corresponding downlink frame, as shown in FIG. 7. T_{TA} may be based on various factors, as listed below:
A round trip propagation delay for signals transmitted between UE and base station.
A hardware switch time for switching between the TX mode and RX mode. For example, the switch time may be the time delay between deactivating RX module and activating TX module, or vice versa.
Frequency range and band, as well as Sub-Carrier Spacing (SCS).

In some embodiments, T_{TA}=(N_{TA}+Nta_offset)*Tc. Tc is the basic time unit for a wireless system such as the 5G NR system. N_{TA} may be obtained by base station via detecting Physical Random Access Channel (PRACH) and/or UL reference signal. N_{TA} may be signaled to the UE via a timing advance command. Nta_offset may be predefined or may be informed by base station to the UE via signaling, such as the “n-TimingAdvanceOffset” signaling. Table 1 below shows example value for Nta_offset.

TABLE 1
The Value of Nta_offset

| Frequency range and band of cell | Nta_offset |
|---|---|
| used for uplink transmission | (Unit: T_{c}) |
| FR1 FDD or TDD band with neither E-UTRA-NR | 25600 (Note 1) |
| nor NB-IoT-NR coexistence case | |
| FR1 FDD band with E-UTRA-NR and/or | 0 (Note 1) |
| NB-IoT-NR coexistence case | |
| FR1 TDD band with E-UTRA-NR and/or | 39936 (Note 1) |
| NB-IoT-NR coexistence case | |
| FR2 | 13792 |

Note 1:
The UE identifies Nta_offset based on the information n-TimingAdvanceOffset. If UE is not provided with the information n-TimingAdvanceOffset, the default value of N_{TA offset} is set as 25600 for FR1 band. In case of multiple UL carriers in the same TAG, UE expects that the same value of n-TimingAdvanceOffset is provided for all the UL carriers. The value 39936 of Nta_offset can also be provided for a FDD serving cell.

In some embodiments, the base station and the UE may each maintain a UL timing and a DL timing. Referring to FIG. 8, the timing advance (TA) for a UE may account for the round trip propagation delay (i.e., 2*Tprop). In addition, not shown in FIG. 8, the timing advance may further be compensated based on Nta_offset.

From UE side, the reference point for the UE initial transmit timing may be the downlink timing of the reference cell minus the value of timing advance. The downlink timing may be the time when the first detected path (in time) of the corresponding downlink frame is received from the reference cell. In some implementations, DL timing may be obtained via the detection of DL reference signal, such as a Synchronization Signal Block (SSB), a Channel State Information Reference Signal (CSI-RS), or the like.

From the base station side, in example implementations, the UL timing is aligned with the DL timing.

### Frame Structure and Slot Format Configuration

In a wireless network, various signaling and/or messages may be provided to configure time blocks (e.g., frame, slot, symbol, etc.). This may include the pattern as described in earlier section (e.g., the “DDDFU” pattern as shown in FIG. 4), the periodicity of the pattern, etc.

The signaling may include cell specific signaling, for example, tdd-UL-DL-ConfigurationCommon. This signaling applies to all the UEs in one cell. Turning back to FIG. 4, this signaling may indicate to the UEs: a pattern of the time blocks, and a periodicity of the time block pattern. For example, a “DDDFU” pattern with a periodicity of 2.5 ms may be signaled.

The indication/configuration described above uses slot as a unit in time domain. In some embodiments, the same underlying principle may apply to a symbol level to gain finer granularities. For example, the periodicity may be presented as a number of OFDM symbols (or equivalent time period corresponding to the number of OFDM symbols). Similarly, the format may also apply to the OFDM symbol. That is, the base station may indicate to the UE a format for each OFDM symbol, whether the symbol is for DL, UL, or flexible purpose.

The signaling may also include UE specific signaling, for example, tdd-UL-DL-ConfigurationDedicated. In some embodiments, the UE specific signaling may override the configuration indicated by the cell specific signaling.

In some embodiments, in case a UE is not provided with either a cell specific signaling or a UE specific signaling, the UE may assume that all slots and/or OFDM symbols are in flexible format.

Once a slot (or slots) or an OFDM symbol (or OFDM symbols) is configured as flexible format, the base station may dynamically schedule transmission resource in the slot or the OFDM symbol with desired direction, whether the direction is DL or UL. For example, referring to FIG. 4, slot 3 is configured as an F slot. In the time domain, the base station may assign this whole slot or at least one OFDM symbol in this slot for UL transmission. In the frequency domain, this resource assignment may occupy all the resources blocks in the whole slot (or the at least one OFDM symbol), or just a portion of them. For example, assuming there is one single carrier in frequency domain which includes 100 resource blocks, in one example assignment, resource blocks 11-20 out of these 100 resource blocks in whole slot 3 may be assigned for UL transmission. In another assignment, resource blocks 50-80 out of these 100 resource blocks in OFDM symbols 8-10 of slot 3 may be assigned for UL transmission.

By using signaling described above, a transmission resource may be configured with an initial configuration including an initial pattern. Still referring to FIG. 4, a slot pattern 402 may be configured as “DDDFU” using aforementioned signaling scheme. The slot pattern 402 may be configured with an exemple periodicity equal to 2.5 ms.

In some implementations, the transmission resource may be limited in a single cell, or a single carrier.

### SBFD Transceiver Structures

For implementing the SBFD feature, there are two types of SBFD transceiver structures.

### SBFD Transceiver Structure 1

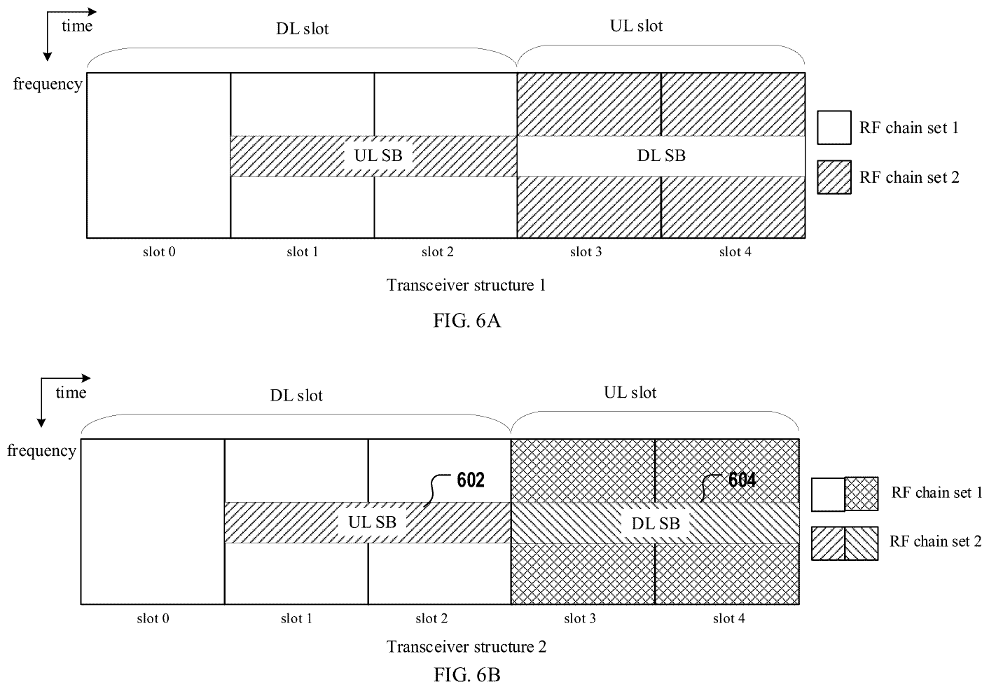

In SBFD transceiver structure 1, the Transmitting (Tx) antenna array and Receiving (Rx) antenna array are separated. Transmission and reception at a base station (e.g., gNB, ng-eNB, etc.) are each performed by a different set of Radio Frequency (RF) chains. Referring to FIG. 6A, RF chain set 1 is the RX RF chain which always operates under RX mode, and RF chain set 2 is the TX RF chain which always operates under TX mode. RF chain set 1 covers DL slot 0, DL portion of DL slots 1 and 2, and DL portion of UL slots 3 and 4. RF chain set 2 covers the UL sub-band in DL slots 1 and 2, and UL portion of UL slots 3 and 4. There needs to be isolation between these two set of RF chains to suppress self-interference. The structure 1 is simple and cost-efficient from design and implementation perspective. Self-interference cancellation is only needed in the RX RF chain. On hardware side, TX RF chain requires TX module whereas no RX module is needed, and the RX RF chain requires RX module whereas no TX module is needed. The downside of structure 1 is the loss of channel reciprocity which is critical for TDD system, especially TDD system with massive MIMO due to the isolation between the two set of RF chains. As background information, channel reciprocity may enable obtaining DL channel state via UL measurement, which may dramatically reduce Channel State Information (CSI) feedback overhead and boost TDD system performance. As background information, in a New Radio (NR) system, when one DL (or UL) channel/signal is configured as reference channel/signal for another UL (or DL) channel/signal, channel reciprocity can be assumed between the DL and UL channel/signal.

### SBFD Transceiver Structure 2

In SBFD transceiver structure 2, the TX/RX antenna array is shared between different sets of RF chains at base station. Referring to FIG. 6B, there exist RF chain set 1 and RF chain set 2. At least one RF chain is configured with both TX module and RX module, for DL transmission and UL transmission, respectively. The RF chain may switch between DL and UL mode according to DL/UL allocation. For example, as shown in FIG. 6B, RF chain set 1 is in DL mode in DL slot 0-2, then switches to UL mode in slot 3-4. For another example, RF chain set 2 is in UL mode in slots 1-2 (for the UL SB 602), then switches to DL mode in slot 3-4 (for the DL SB 604). It may be observed that in slots 3 and 4, both RF chain sets are operating: RF chain set 1 operates in UL mode, and RF chain set 2 operates in DL mode.

In SBFD transceiver structure 2, channel reciprocity may be achieved as the RF chain set is configured with both RX module and TX module. Note that there is still isolation between two sets of RF chains. However, the downside of structure 2 may include high complexity and cost, as more RX modules and TX modules are required, and each set of RF chain needs the functionality of self-interference cancellation.

Under SBFD implementation, if Nta_offset is set to larger than 0 as in legacy TDD system, the DL and UL sub-bands are not aligned in time domain, which imposes higher self-interference. As one solution, it is possible to make Nta_offset equal to 0. This may work for transceiver structure 1 since DL/UL switching is not needed when transmission and reception are implemented by two different sets of RF chains. However, for transceiver structure 2, DL/UL switching may occur within a RF chain set and the switching time may not be ignored. Therefore, the assumption that Nta_offset is equal to 0 may not hold under transceiver structure 2. The DL/UL switching time may need to be compensated under transceiver structure 2 implementation.

In this disclosure, various embodiments are described for obtaining DL and/or UL timing to realize alignment between the resources assigned with different link direction and to alleviate self-interference issue. Meanwhile, channel reciprocity is retained in these embodiments, which significantly reduce CSI feedback overhead and boost system performance.

In embodiments below, for exemplary purpose only, time unit in slot is used. Same underlying principle applies to other types of time blocks, such as symbol, frame, mini slot, etc.

In embodiments below, the slot configuration (or referred to as slot patter), such as “DDFFU”, is for exemplary purpose only. Same underlying principle applies to other slot patterns.

In embodiments below, a gNB is used as an example base station. Same underlying principle applies to other types of base stations, such as eNB, gn-eNB, eNodeB, etc.

### Embodiment 1

In this embodiment, the slot configuration is DDFFU (D: DL slot; U: UL slot; F: flexible slot), which may be indicated to the UE via cell specific signaling, such as “tdd-UL-DL-ConfigurationCommon”.

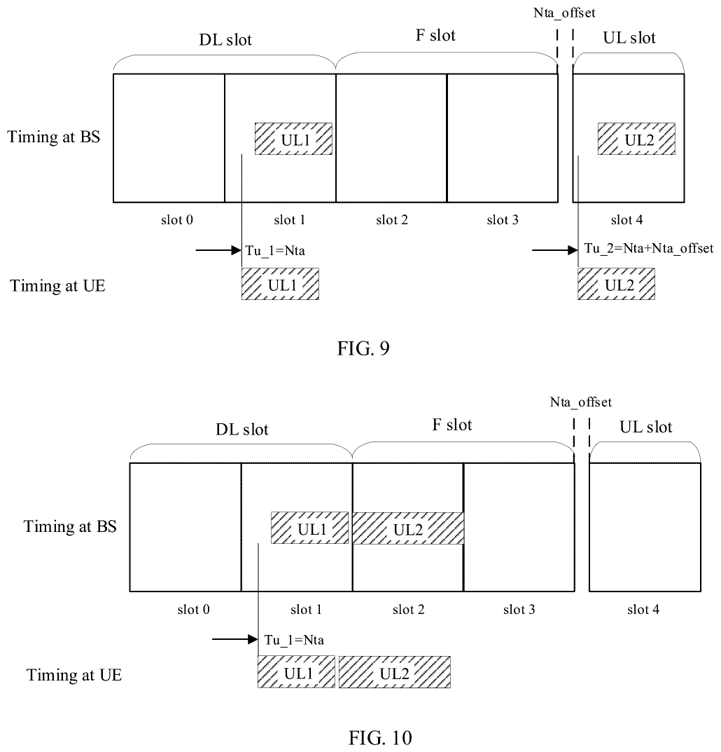

Referring to FIG. 9, there are two UL timings configured for UE. For UL1 transmitted in DL slot, a first UL timing, Tu_1=Nta is used. For UL2 transmitted in UL slot, a second UL timing, Tu_2=Nta+Nta_offset is used. Detailed description for Nta and Nta_offset may be found in previous sections.

Meanwhile, there are two UL timings configured at gNB. The UL channel/signal in DL slot is aligned with timing of DL slot. The UL channel/signal in UL slot is aligned with timing of UL slot.

In some example implementations, the UL channel/signal may be generally referred to as a UL transmission, and the DL channel/signal may be generally referred to as a DL transmission.

### Embodiment 2

In this embodiment, the slot configuration is DDFFU, which may be indicated to the UE via cell specific signaling, such as “tdd-UL-DL-ConfigurationCommon”.

Referring to FIG. 10, from UE side, the UL timing for UE in flexible slot may be configured as Tu_1 =Nta, which is the same as the UL timing in DL slot.

Meanwhile, from gNB side, there are two UL timings at gNB. The UL channels/signals in DL slot and flexible slot are aligned with timing of DL slot. The UL channel/signal in UL slot is aligned with timing of UL slot.

### Embodiment 3

In this embodiment, the slot configuration is DDFFU, which may be indicated to the UE via cell specific signaling, such as “tdd-UL-DL-ConfigurationCommon”.

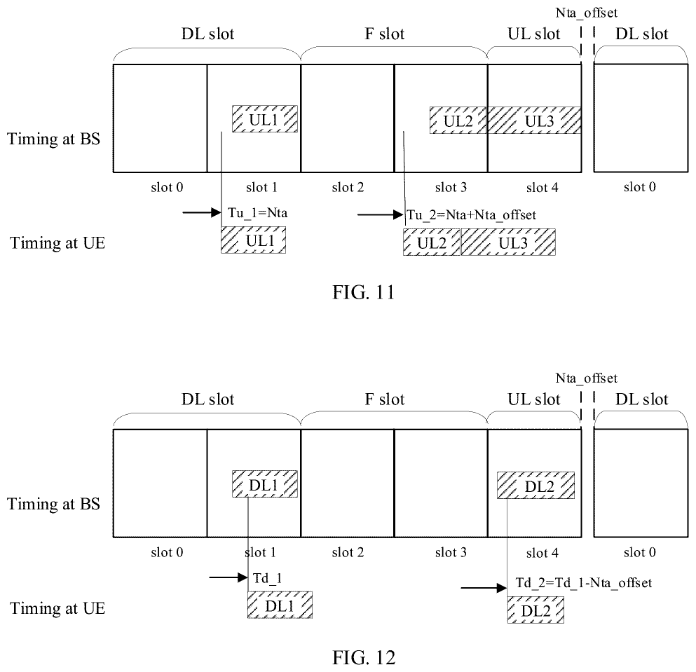

Referring to FIG. 11, from UE side, the UL timing for UE in flexible slot may be configured as Tu_2=Nta+Nta_offset, which is the same as the UL timing in UL slot. For UL transmitted in DL symbols/slots, Tu_1=Nta may be used.

Meanwhile, from gNB side, there are two UL timings at gNB. The UL channels/signal in DL slot is aligned with timing of DL slot. The UL channel/signal in UL slot and flexible slot is aligned with timing of UL slot.

### Embodiment 4

In this embodiment, the slot configuration is DDFFU (D: DL slot; U: UL slot; F: flexible slot), which may be indicated to the UE via cell specific signaling, such as “tdd-UL-DL-ConfigurationCommon”.

Referring to FIG. 12, from UE side, there are two DL timings configured for UE. For DL1 transmitted in DL slot, a first DL timing, Td_1, may be obtained via, for example, the detection of SSB or CSI-RS. For DL2 transmitted in UL slot, a second DL timing, Td_2=Td_1-Nta_offset may be configured.

Meanwhile, there are two DL timings at gNB. The DL channel/signal in DL slot is aligned with timing of DL slot. The DL channel/signal in UL slot is aligned with timing of UL slot, which may be Nta_offset ahead of DL timing of DL channel/signal in DL slot with a same slot index.

### Embodiment 5

In this embodiment, the slot configuration is DDFFU (D: DL slot; U: UL slot; F: flexible slot), which may be indicated to the UE via cell specific signaling, such as “tdd-UL-DL-ConfigurationCommon”.

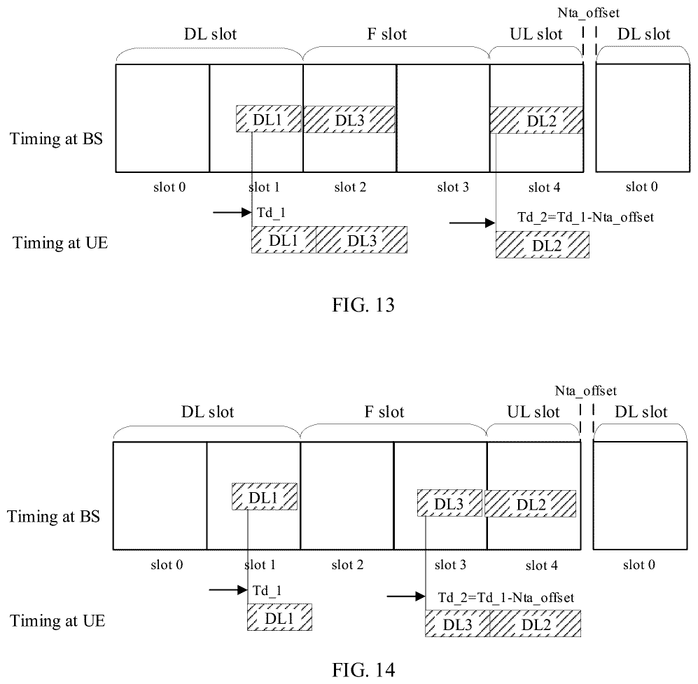

Referring to FIG. 13, from UE side, there are two DL timings configured for UE. For DLI transmitted in DL slot and DL3 transmitted in flexible slot, a first DL timing, Td_1,may be obtained via, for example, the detection of SSB or CSI-RS. For DL2 transmitted in UL slot, a second DL timing, Td_2=Td_1-Nta_offset may be configured.

Meanwhile, there are two DL timings at gNB. The DL channel/signal in DL slot and flexible slot is aligned with timing of DL slot. The DL channel/signal in UL slot is aligned with timing of UL slot, which may be Nta_offset ahead of DL timing of DL channel/signal in DL slot with a same slot index.

### Embodiment 6

In this embodiment, the slot configuration is DDFFU (D: DL slot; U: UL slot; F: flexible slot), which may be indicated to the UE via cell specific signaling, such as “tdd-UL-DL-ConfigurationCommon”.

Referring to FIG. 14, from UE side, there are two DL timings configured for UE. For DLI transmitted in DL slot, a first DL timing, Td_1, may be obtained via, for example, detection of SSB or CSI-RS. For DL2 transmitted in UL slot and DL3 transmitted in flexible slot, a second DL timing, Td_2=Td_1-Nta_offset may be configured.

Meanwhile, there are two DL timings at gNB. The DL channel/signal in DL slot is aligned with timing of DL slot. The DL channel/signal in UL slot and flexible slot is aligned with timing of UL slot, which may be Nta_offset ahead of DL timing of DL channel/signal in DL slot with a same slot index.

### Embodiment 7

In this embodiment, the slot configuration is DDFFU (D: DL slot; U: UL slot; F: flexible slot), which may be indicated to the UE via cell specific signaling, such as “tdd-UL-DL-ConfigurationCommon”.

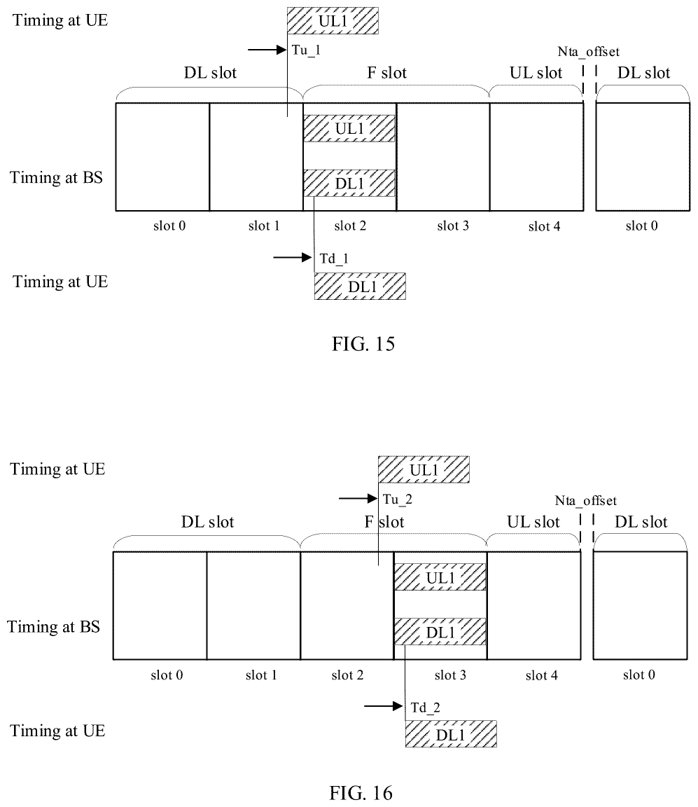

In previous embodiments, 2 DL timings and 2 UL timings for UE are described. In this embodiment, as shown in FIG. 15, on the UE side, for flexible slot, the first DL timing Td_1 is used in combination with the first UL timing Tu_1.

In one implementation, Td_1 may be obtained via, for example, the detection of SSB or CSI-RS. Tu_1 may be configured as Nta.

### Embodiment 8

In this embodiment, the slot configuration is DDFFU (D: DL slot; U: UL slot; F: flexible slot), which may be indicated to the UE via cell specific signaling, such as “tdd-UL-DL-ConfigurationCommon”.

In previous embodiments, 2 DL timings and 2 UL timings for UE are described. In this embodiment, as shown in FIG. 16, for flexible slot, the second DL timing Td_2 is used in combination with the second UL timing Tu_2.

In one implementation, Tu_2=Nta+Nta_offset, and Td_2=Td_1-Nta_offset.

### Embodiment 9

In this embodiment, the slot configuration is DDFFU (D: DL slot; U: UL slot; F: flexible slot), which may be indicated to the UE via cell specific signaling, such as “tdd-UL-DL-ConfigurationCommon”.

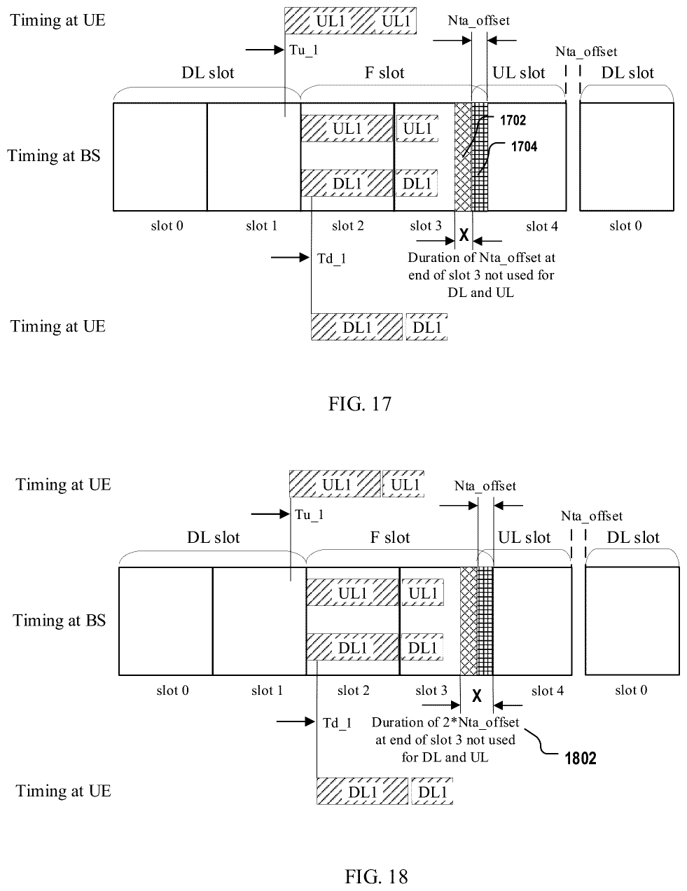

Referring to FIG. 17, for flexible slots 2 and 3, the first DL timing Td_1 is used in combination with the first UL timing Tu_1. Notice that flexible slots 2 and 3 have both DL transmission and UL transmission scheduled. The previous slot of slot 2 is a DL slot, and the next slot of slot 3 is a UL slot. In this embodiment, a duration 1702, which equals to Nta offset and is at the end of slot 3 is excluded from any UL/DL transmissions, including UL/DL channel/signals. The duration 1702 may serve as a guard interval for switching delay, for example, for an RF chain serving DLI in slot 3 to switch to UL mode to serve uplink transmission in UL slot 4. Notice that the duration 1702 is at the end of continuous flexible slots. In case there is only one flexible slot in between slots of other formats, the duration 1702 is at the end of the only one flexible slot.

In one implementation, Td_1 may be obtained via, for example, the detection of SSB or CSI-RS. Tu_1 may be configured as Nta.

Notice that in FIG. 17, from gNB side, flexible slot 3 and UL slot 4 have an overlap duration 1704. This is to illustrate that the gNB is using two different timings. For example, the timing used for ULI or DLI in flexible slot 3 is different from the timing used for UL transmission in UL slot 4.

### Embodiment 10

In this embodiment, the slot configuration is DDFFU (D: DL slot; U: UL slot; F: flexible slot), which may be indicated to the UE via cell specific signaling, such as “tdd-UL-DL-ConfigurationCommon”.

Referring to FIG. 18, for flexible slots 2 and 3, the first DL timing Td_1 is used in combination with the first UL timing Tu_1. Notice that flexible slots 2 and 3 have both DL transmission and UL transmission scheduled. The previous slot of slot 2 is a DL slot, and the next slot of slot 3 is a UL slot. In this embodiment, a duration 1802 which equals to 2*Nta_offset and is at the end of slot 3 is excluded from any UL/DL transmissions, including UL/DL channel/signals. The duration 1802 may serve as a guard interval for mode switching between DL mode and UL mode. Notice that the duration 1802 is at the end of continuous flexible slots. In case there is only one flexible slot in between slots of other formats, the duration 1802 is at the end of the only one flexible slot.

In one implementation, Td_1 may be obtained via, for example, the detection of SSB or CSI-RS. Tu_1 may be configured as Nta.

### Embodiment 11

In this embodiment, the slot configuration is DDFFU (D: DL slot; U: UL slot; F: flexible slot), which may be indicated to the UE via cell specific signaling, such as “tdd-UL-DL-ConfigurationCommon”.

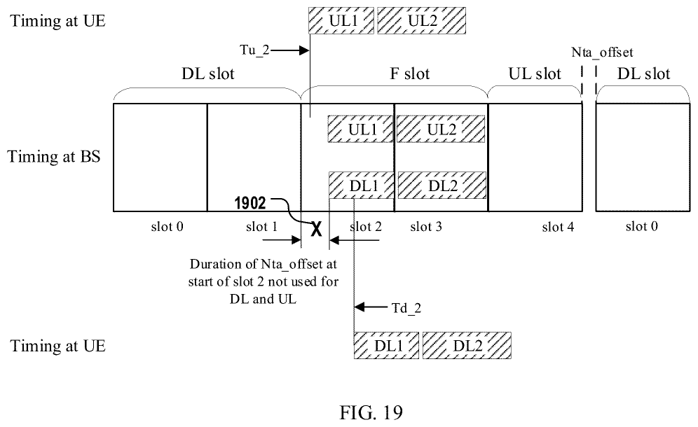

Referring to FIG. 19, for flexible slots 2 and 3, the second DL timing Td_2 is used in combination with the second UL timing Tu_2. Notice that flexible slots 2 and 3 have both DL transmission and UL transmission scheduled. The previous slot of slot 2 is a DL slot, and the next slot of slot 3 is a UL slot. In this embodiment, a duration 1902 which equals to Nta_offset and starts from beginning of slot 2 is excluded from any UL/DL transmissions, including UL/DL channel/signals. Notice that the duration 1902 start from the beginning of continuous flexible slots. In case there is only one flexible slot in between slots of other formats, the duration 1902 starts from the only one flexible slot.

In one implementation, Tu_2=Nta+Nta_offset, and Td_2=Td_1-Nta_offset.

### Embodiment 12

Embodiments above describe that both base station and UE may each have two UL timings and two DL timings. The quantify of the UL/DL timings may be predefined, or may be indicated by the base station to the UE.

In one implementation, the gNB may signal the UE to add one UL/DL timing on top of existing timing.

In one implementation, the gNB may signal the UE to reduce the quantity of UL/DL timings to just one UL timing and/or one DL timing.

In one implementation, when there is only one UL timing, the first UL timing is configured or used. In this case, Nta_offset=0.

In one implementation, when there is only one DL timing, the first DL timing is configured or used. In this case, the DL timing may be obtained via the detection of DL reference signal, such as a SSB, a CSI-RS), or the like.

In above embodiments, the transmission resource may be limited in a single cell, or a single carrier.

The embodiments above may specifically apply to the SBFD transceiver structure 2.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

1. A method for wireless communication, performed by a wireless device, the method comprising at least one of:
configuring two downlink (DL) timings for DL transmission from a network element, wherein the two DL timings include a first DL timing and a second DL timing, and wherein the network element comprises a base station; or
configuring two uplink (UL) timings for UL transmission to the network element, wherein the two UL timings include a first UL timing and a second UL timing; and
wherein each of the two DL timings and each of the two UL timings are associated with a time block for the DL transmission or the UL transmission.

2. (canceled)

3. The method of claim 1, wherein:
the first DL timing is determined based on a reference signal, the reference signal comprising at least one of: a Synchronization Signal Block (SSB), or a Channel State Information Reference Signal (CSI-RS).

4. The method of claim 3, wherein:
the second DL timing is based on the first DL timing, and a timing advance offset value; and
the method further comprising:
receiving, from the network element, the timing advance offset value; or
determining the timing advance offset value based on predefined value. 5-6. (canceled)

7. The method of claim 4, wherein the timing advance offset value is based on a switching delay time between a UL mode and a DL mode of a hardware circuitry of the network element.

8. The method of claim 1, further comprising selecting a UL timing from the two UL timings for a UL transmission based on at least one of:
a time domain information of a resource allocated for the UL transmission; or
a frequency domain information of the resource allocated for the UL transmission.

9. The method of claim 1, further comprising:
in response to a UL transmission being scheduled in a DL format time block, selecting the first UL timing for the UL transmission;
in response to the UL transmission being scheduled in a UL format time block, selecting the second UL timing for the UL transmission; and
in response to the UL transmission being scheduled in a flexible format time block, selecting one of the two UL timings for the UL transmission, based on a signaling provided by the network element or a predefined rule.

10. The method of claim 9, wherein a unit for the DL format time block, the UL format time block, and the flexible format time block comprises at least one of:
a time slot; or
a symbol.

11. The method of claim 1, further comprising selecting a DL timing from the two DL timings for a DL transmission based on at least one of:
a time domain information of a resource allocated for the DL transmission; or
a frequency domain information of the resource allocated for the DL transmission.

12. The method of claim 1, further comprising:
in response to a DL transmission being scheduled in a DL format time block, selecting the first DL timing for the DL transmission;
in response to the DL transmission being scheduled in a UL format time block, selecting the second DL timing for the UL transmission; and
in response to the DL transmission being scheduled in a flexible format time block, selecting one of the two DL timings for the DL transmission, based on a signaling provided by the network element or a predefined rule.

13. The method of claim 1, further comprising:
receiving, from the network element, a signaling scheduling a DL reception in a flexible format time block and a UL transmission in the flexible format time block;
determining timing information following one of:
selecting the first DL timing for the DL transmission in the flexible format time block, and selecting the first UL timing for the UL transmission in in the flexible format time block; or
selecting the second DL timing for the DL transmission in the flexible format time block, and selecting the second UL timing for the UL transmission in in the flexible format time block.

14. The method of claim 1, wherein the second UL timing is based on a timing advance offset value, the method further comprising:
in response to at least one of: the first DL timing being applied to a DL transmission scheduled in a flexible format time block, or the first UL timing being applied to a UL transmission scheduled in the flexible format time block, wherein a format of a time block next to the flexible format time block is not flexible format, determining that a duration finishing at an end of the flexible format time block is excluded for DL reception or UL transmission, wherein the duration is based on the timing advance offset value.

15. The method of claim 14, wherein the duration equals to the timing advance offset value or 2 times the timing advance offset value.

16. The method of claim 1, wherein the second UL timing is based on a timing advance offset value, the method further comprising:
in response to at least one of: the second DL timing being applied to a DL reception scheduled in a flexible format time block, or the second UL timing being applied to a UL transmission scheduled in the flexible format time block, wherein a format of a time block previous to the flexible format time block is not flexible format, determining that a duration starting from beginning of the flexible format time block is excluded for DL reception or UL transmission, wherein the duration is based on the timing advance offset value.

17. The method of claim 16, wherein the duration equals to the timing advance offset value.

18. The method of claim 1, further comprising at least one of:
determining that a UL channel following the first UL timing to be a reference channel for a DL channel following the second DL timing;
determining that a UL signal following the first UL timing to be a reference signal for a DL signal following the second DL timing;
determining that a DL channel following the second DL timing to be a reference channel for a UL channel following the first UL timing; or determining that a DL signal following the second DL timing to be a reference signal for a UL signal following the first UL timing.

19. The method of claim 1, further comprising at least one of:
determining that a UL channel following the second UL timing to be a reference channel for a DL channel following the first DL timing;
determining that a UL signal following the second UL timing to be a reference signal for a DL signal following the first DL timing;
determining that a DL channel following the first DL timing to be a reference channel for a UL channel following the second UL timing; or
determining that a DL signal following the first DL timing to be a reference signal for a UL signal following the second UL timing.

20. The method of claim 1, further comprising:
adjusting a quantity of the DL timings so only the first DL timing is configured based on a signaling from the network element or a predefined rule; or
adjusting a quantity of the UL timings so only the first UL timing is configured based on a signaling from the network element or a predefined rule.

21-33. (canceled)

34. A wireless device comprising a memory for storing computer instructions and a processor in communication with the memory, wherein, when the processor executes the computer instructions, the processor is configured to cause the wireless device to:
configure two downlink (DL) timings for DL transmission from a network element, wherein the two DL timings include a first DL timing and a second DL timing, and wherein the network element comprises a base station; or
configure two uplink (UL) timings for UL transmission to the network element, wherein the two UL timings include a first UL timing and a second UL timing; and
wherein each of the two DL timings and each of the two UL timings are associated with a time block for the DL transmission or the UL transmission.

35. The wireless device of claim 34, wherein:
the first DL timing is determined based on a reference signal, the reference signal comprising at least one of: a Synchronization Signal Block (SSB), or a Channel State Information Reference Signal (CSI-RS).

36. A non-transitory storage medium for storing computer readable instructions, the computer readable instructions, when executed by a processor in a first network node, causing the processor to:
configure two downlink (DL) timings for DL transmission from a network element, wherein the two DL timings include a first DL timing and a second DL timing, and wherein the network element comprises a base station; or
configure two uplink (UL) timings for UL transmission to the network element, wherein the two UL timings include a first UL timing and a second UL timing; and
wherein each of the two DL timings and each of the two UL timings are associated with a time block for the DL transmission or the UL transmission.
